(19) United States
(12) Patent Application Publication
(10) Pub. No.: US 2022/0398614 A1
(43) Pub. Date: Dec. 15, 2022

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventor: Go TEJIMA, Toyota-shi (JP)

(73) Assignee: TOYOTA JIDOSHA KABUSHIKI KAISHA, Toyota-shi (JP)

(21) Appl. No.: 17/804,327

(22) Filed: May 27, 2022

(30) Foreign Application Priority Data
Jun. 11, 2021 (JP) 2021-097938

(51) Int. Cl. G06Q 30/02; G06Q 10/02; B60K 15/03

(52) U.S. Cl. CPC G06Q 30/0206; G06Q 10/02; B60K 15/03; B60K 2015/03315

(57) ABSTRACT

An information processing apparatus capable of accurately predicting demand for hydrogen at hydrogen stations is provided. An information processing apparatus includes an input data acquisition unit and a prediction unit. The input data acquisition unit acquires a behavior pattern of a customer regarding a vehicle that uses hydrogen as a fuel. The prediction unit predicts the demand for hydrogen at least one hydrogen station using a demand prediction model, which is a trained model generated by machine learning in advance, the demand prediction model receiving at least the behavior pattern and outputting a predicted demand for hydrogen.

### CROSS REFERENCE TO RELATED APPLICATIONS

This application is based upon and claims the benefit of priority from Japanese patent application No. 2021-097938, filed on Jun. 11, 2021, the disclosure of which is incorporated herein in its entirety by reference.

### BACKGROUND

The present disclosure relates to an information processing apparatus, an information processing method, and a program, and in particular, to an information processing apparatus, an information processing method, and a program that predict demand for hydrogen at hydrogen stations.

Japanese Unexamined Patent Application Publication No. 2016-183768 discloses a method of controlling a reservation system at a hydrogen station for the purpose of smoothly fueling vehicles with hydrogen fuel. The method disclosed in Japanese Unexamined Patent Application Publication No. 2016-183768 allows reservation information for reserving the date and time when a user fuels his/her vehicle with hydrogen fuel at a hydrogen station to be input and creates a hydrogen fueling reservation table that can register the input reservation information. Further, according to the method disclosed in Japanese Unexamined Patent Application Publication No. 2016-183768, a required amount of hydrogen fuel on a focused day, which is the day a predetermined number of days after the day read out using the hydrogen fueling reservation table which registers reservation information input by the user, is calculated.

### SUMMARY

According to the technique disclosed in Japanese Unexamined Patent Application Publication No. 2016-183768, it is impossible to know whether a user will visit a hydrogen station unless the user makes a reservation to visit the hydrogen station. Therefore, even when the demand for hydrogen at the hydrogen station is to be predicted using the technique disclosed in Japanese Unexamined Patent Application Publication No. 2016-183768, the prediction accuracy may not be sufficiently high.

The present disclosure provides an information processing apparatus, an information processing method, and a program capable of accurately predicting the demand for hydrogen at hydrogen stations.

An information processing apparatus according to the present disclosure includes: an acquisition unit configured to acquire a behavior pattern of a customer regarding a vehicle that uses hydrogen as a fuel; and a prediction unit configured to predict demand for hydrogen at least one hydrogen station using a demand prediction model, which is a trained model generated by machine learning in advance, the demand prediction model receiving at least the behavior pattern and outputting a predicted demand for hydrogen.

Further, the information processing method according to the present disclosure includes: acquiring a behavior pattern of a customer regarding a vehicle that uses hydrogen as a fuel; and predicting demand for hydrogen at least one hydrogen station using a demand prediction model, which is a trained model generated by machine learning in advance, the demand prediction model receiving at least the behavior pattern and outputting a predicted demand for hydrogen.

Further, a program according to the present disclosure causes a computer to execute the following processing of: acquiring a behavior pattern of a customer regarding a vehicle that uses hydrogen as a fuel; and predicting demand for hydrogen at least one hydrogen station using a demand prediction model, which is a trained model generated by machine learning in advance, the demand prediction model receiving at least the behavior pattern and outputting a predicted demand for hydrogen.

The present disclosure is configured to predict the demand for hydrogen using a behavior pattern of a customer, whereby it is possible to predict the demand for hydrogen even when the customer does not make a reservation. Therefore, the present disclosure is able to accurately predict the demand for hydrogen.

Further, the prediction unit may decide, based on the predicted demand, an amount of hydrogen that can be supplied in accordance with a timing.

According to the present disclosure configured as described above, it becomes possible to stabilize revenues at hydrogen stations.

Further, the prediction unit may decide, based on the predicted demand, a timing when high-pressure gas of hydrogen is prepared.

According to the present disclosure configured as described above, it becomes possible to reduce the opportunity loss resulting from not being able to supply hydrogen to a vehicle when a customer visits a hydrogen station.

Further, the prediction unit may predict the demand for hydrogen based on a timing when the customer fuels his/her vehicle with hydrogen, which is indicated by the behavior pattern.

According to the present disclosure configured as described above, the accuracy of predicting the demand for hydrogen may be improved.

Further, the prediction unit may predict the demand for hydrogen based on reservation information from the customer, which is indicated by the behavior pattern.

According to the present disclosure configured as described above, the accuracy of predicting the demand for hydrogen may be improved.

Further, the information processing apparatus may further include a learning unit configured to perform machine learning on the demand prediction model, in which the learning unit continuously performs learning on the demand prediction model in accordance with a difference between the demand predicted by the prediction unit and an actual demand.

According to the present disclosure configured as described above, it is possible to further improve the accuracy of predicting the demand.

Further, the information processing apparatus may further include a notification unit configured to notify, in accordance with the predicted demand, a customer of a timing and a hydrogen station where hydrogen can be supplied.

According to the present disclosure configured as described above, it becomes possible to perform an adjustment between demand for hydrogen and supply of hydrogen more definitely.

Further, a hydrogen station group may be composed of a plurality of hydrogen stations, and the notification unit may notify the customer that, when an amount of hydrogen that can be actually supplied at one hydrogen station becomes lower than a predicted demand amount at this hydrogen station, hydrogen can be supplied at another hydrogen station capable of supplying hydrogen in the hydrogen station group to which the hydrogen station that cannot supply a sufficient amount of hydrogen belongs.

According to the present disclosure configured as described above, it is possible to balance the hydrogen supply in a hydrogen station group.

According to the present disclosure, it is possible to provide an information processing apparatus, an information processing method, and a program capable of accurately predicting the demand for hydrogen at hydrogen stations.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing an information processing system according to a first embodiment;

FIG. 2 is a diagram showing a hardware configuration of an information processing apparatus according to the first embodiment;

FIG. 3 is a block diagram showing a configuration of the information processing apparatus according to the first embodiment;

FIG. 4 is a diagram illustrating input data input to a demand prediction model according to the first embodiment;

FIG. 5 is a diagram illustrating feature amounts in the input data according to the first embodiment;

FIG. 6 is a diagram illustrating a customer behavior pattern according to the first embodiment;

FIG. 7 is a diagram illustrating a customer behavior pattern according to the first embodiment;

FIG. 8 is a diagram illustrating a customer behavior pattern according to the first embodiment;

FIG. 9 is a diagram illustrating a customer behavior pattern according to the first embodiment;

FIG. 10 is a diagram illustrating output data output from the demand prediction model according to the first embodiment;

FIG. 11 is a diagram illustrating demand prediction obtained by a demand prediction unit according to the first embodiment;

FIG. 12 is a flowchart showing an information processing method executed by the information processing apparatus according to the first embodiment;

FIG. 13 is a flowchart showing the information processing method executed by the information processing apparatus according to the first embodiment;

FIG. 14 is a diagram illustrating a hydrogen station group according to a second embodiment;

FIG. 15 is a block diagram showing a configuration of an information processing apparatus according to a second embodiment; and

FIG. 16 is a flowchart showing an information processing method executed by the information processing apparatus according to the second embodiment.

### DESCRIPTION OF EMBODIMENTS

### First Embodiment

Hereinafter, with reference to the drawings, embodiments of the present disclosure will be described. For the sake of clarification of the description, the following descriptions and the drawings are omitted and simplified as appropriate. Further, throughout the drawings, the same elements are denoted by the same symbols and overlapping descriptions are omitted as necessary.

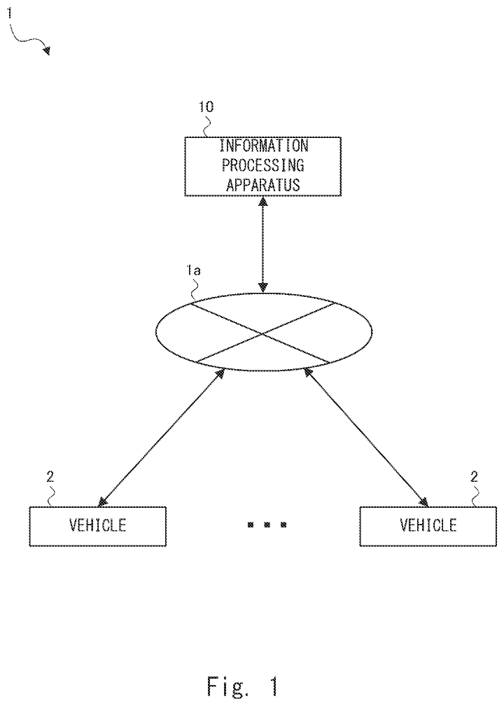

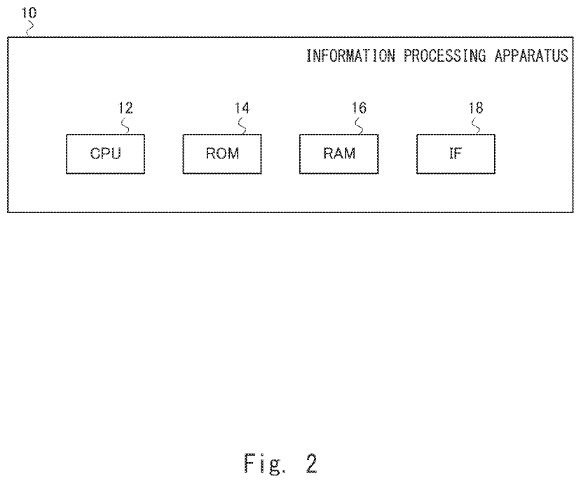

FIG. 1 is a diagram showing an information processing system 1 according to the first embodiment. The information processing system 1 includes a plurality of vehicles 2 and an information processing apparatus 10. The vehicles 2 are vehicles (e.g., fuel cell electric vehicles) that use hydrogen as a fuel. The information processing apparatus 10 is, for example, a computer such as a server. The information processing apparatus 10 and each of the vehicles 2 may be connected to each other in such a way that they can communicate with each other via a network 1a such as a wireless network. Note that the vehicles 2 may each have a hardware configuration of the information processing apparatus 10, which will be described later with reference to FIG. 2.

The information processing apparatus 10 predicts a demand for hydrogen at hydrogen stations that supply hydrogen to the vehicles 2. Specifically, the information processing apparatus 10 predicts the demand for hydrogen by an algorithm of machine learning such as deep learning, a neural network, or a recurrent neural network. The information processing apparatus 10 may be implemented by one or more computers. Further, the information processing apparatus 10 may be implemented by a cloud system. Therefore, the information processing apparatus 10 is not limited to be implemented by a physically one apparatus.

FIG. 2 is a diagram showing a hardware configuration of the information processing apparatus 10 according to the first embodiment. The information processing apparatus 10 includes, as a main hardware configuration, a Central Processing Unit (CPU) 12, a Read Only Memory (ROM) 14, a Random Access Memory (RAM) 16, and an interface unit (IF) 18. The CPU 12, the ROM 14, the RAM 16, and the interface unit 18 are connected to one another via a data bus or the like.

The CPU 12 has a function as an arithmetic apparatus (a processing device or a processor) that performs, for example, control processing and arithmetic processing. The arithmetic apparatus may be implemented by an apparatus such as a Neural network Processing Unit (NPU) or a Graphics Processing Unit (GPU) which is dedicated for machine learning. The ROM 14 has a function as a storage for storing, for example, a control program(s) and an arithmetic program(s) executed by the CPU 12 (arithmetic apparatus). The RAM 16 has a function as a memory that temporarily stores processing data and the like. The interface unit 18 has a function as a communication apparatus that externally receives/outputs signals through a wire or wirelessly. Further, the interface unit 18 has a function as a user interface that accepts an operation for inputting data performed by a user and performs processing for displaying information for the user. The interface unit 18 may display results of demand prediction.

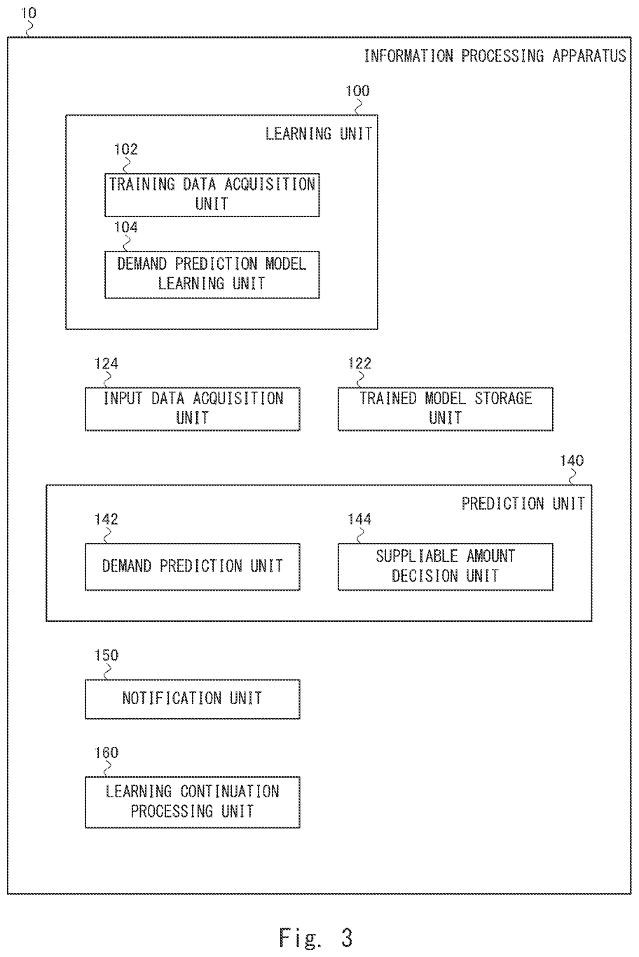

FIG. 3 is a block diagram showing a configuration of the information processing apparatus 10 according to the first embodiment. The information processing apparatus 10 according to the first embodiment includes a learning unit 100, a trained model storage unit 122, an input data acquisition unit 124 (acquisition unit), a prediction unit 140, a notification unit 150, and a learning continuation processing unit 160. The learning unit 100 includes a training data acquisition unit 102 and a demand prediction model learning unit 104. The prediction unit 140 includes a demand prediction unit 142 and a suppliable amount decision unit 144.

The above components may be implemented by, for example, the CPU 12 (arithmetic apparatus) executing a program stored in the ROM 14 (storage apparatus). Further, each of these components may be implemented by storing necessary programs in a desired non-volatile storage medium in advance and installing them as required. Note that each of these components is not limited to be implemented by software as stated above and may be implemented by hardware such as some circuit elements. Further, one or more of the above components may each be implemented by physically-separate individual hardware. For example, the learning unit 100 may be implemented by hardware separated from the other components.

The learning unit 100 learns a demand prediction model for predicting the demand for hydrogen at hydrogen stations by the aforementioned machine learning algorithm. In other words, the learning unit 100 performs machine learning on the demand prediction model. The learning unit 100 performs machine learning so that it predicts the demand for hydrogen at least using behavior patterns of customers. Therefore, the demand prediction model receives input data including at least customer behavior pattern information indicating the behavior patterns of customers and outputs demand (prediction demand amount of hydrogen (demand prediction amount)) for each hydrogen station. The demand prediction amount indicates the demand amount of hydrogen after a predetermined period (e.g., after one day, after two days, after one week, or after one month).

The training data acquisition unit 102 acquires training data, which is a set of input data and ground truth data (i.e., correct answer data). The input data includes customer behavior pattern information and area information. The input data is time-series data whose values of its feature amounts may change with time.

The customer behavior pattern information indicates behavior patterns of a plurality of respective customers. Therefore, the customer behavior pattern information may be generated for each of the plurality of customers. The customer behavior pattern information may be acquired, for example, from the vehicle 2 that a customer owns via the network 1a. The customer behavior pattern information indicates, for example, a timing when the customer fuels his/her vehicle 2 with hydrogen (the frequency at which the customer fuels his/her vehicle with hydrogen), a hydrogen station that the customer has visited, and a fueling amount when the customer fuels his/her vehicle with hydrogen. The details thereof will be described later.

The area information, which is information that is different from a behavior pattern of a customer, indicates various kinds of information in an area. The area information indicates, for example, weather, information regarding hydrogen stations in the corresponding area, and information regarding events in the corresponding area. The details thereof will be described later.

The ground truth data corresponds to output data at an operational stage (inference stage, prediction stage). As described above, the output data indicates a demand amount of hydrogen after a predetermined period for each hydrogen station. Therefore, the ground truth data corresponds to the actual demand amount of hydrogen at one timing for each hydrogen station.

The demand prediction model learning unit 104 performs processing of learning the demand prediction model using the acquired training data. The demand prediction model may be implemented by, for example, a machine learning algorithm such as deep learning, a neural network, or a recurrent neural network. The demand prediction model learning unit 104 receives the input data and performs learning of the demand prediction model in such a way that a difference between the predicted value and the ground truth data becomes small. The demand prediction model learning unit 104 performs adjustment or the like of a parameter, which is a weight, in such a way that the difference between the predicted value and the ground truth data becomes small. The demand prediction model learning unit 104 may generate the demand prediction model using training data in a certain period (e.g., a few months) as data for learning. Then, the demand prediction model learning unit 104 may adjust the parameter (weight or the like) of the demand prediction model using training data in a predetermined period (e.g., a few weeks) after the above period as data for evaluation. Further, the demand prediction model learning unit 104 may extract important feature amounts from the input data by an autoencoder.

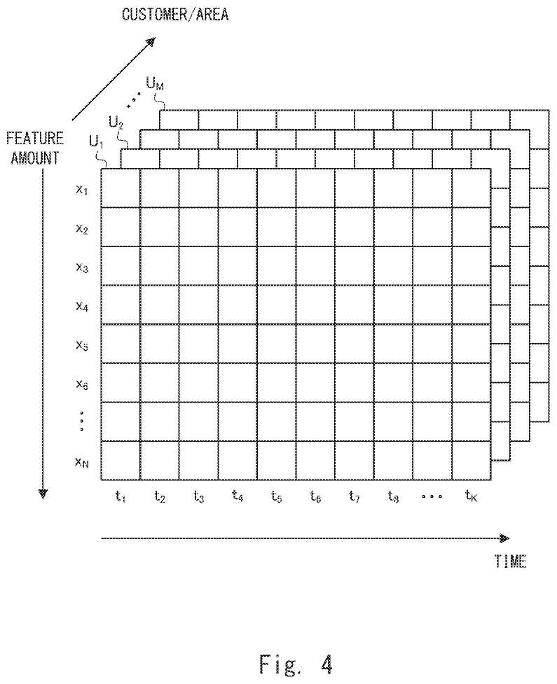

FIG. 4 is a diagram illustrating the input data input to the demand prediction model according to the first embodiment. As illustrated in FIG. 4, the input data is time-series data of a plurality of feature amounts. In the example shown in FIG. 4, the input data in which the horizontal axis is the time axis and the vertical axis indicates the feature amounts in the time series is shown. That is, each of the feature amounts x₁, x₂, x₃, . . . , and x_{N} is time-series data. The symbol N denotes the number of feature amounts. The feature amounts may be sampled, for example, for every predetermined period Δt. In this case, the time intervals between t₁, t₂, t₃, . . . ,tₖ in the horizontal axis in FIG. 4 are Δt. Further, Δt may be, for example, 30 minutes, one hour, six hours, or one day (24 hours). This sampling period Δt may be set as appropriate depending on how fine in the time series the demand prediction is desired to be obtained. For example, the sampling period Δt in a case in which it is desired to obtain demand prediction for every few hours may be shorter than the sampling period Δt in a case in which it is desired to obtain demand prediction for every few days.

Further, the input data may be generated for each customer and for each area. For example, input data (customer behavior pattern information) U₁, U₂, and U₃ for a customer #1, a customer #2, and a customer #3 are respectively generated. Further, for example, input data (area information) Uₘ₊₁, Uₘ₊₂, and Uₘ₊₃ for an area #1, an area #2, and an area #3 are respectively generated. The set of input data U₁-U_{M} is input to the demand prediction model as the input data.

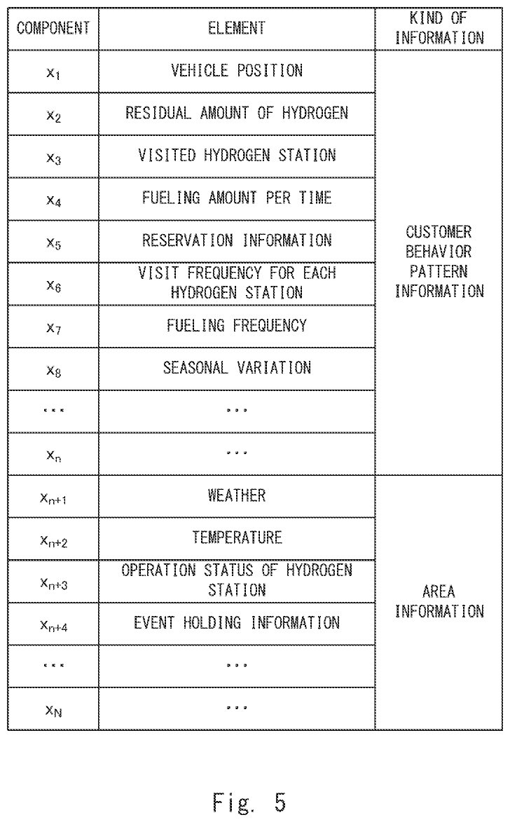

FIG. 5 is a diagram illustrating the feature amounts in the input data according to the first embodiment. Note that the feature amounts illustrated in FIG. 5 are merely examples and other various feature amounts may be employed. In FIG. 5, components x₁-xₙ indicate feature amounts in the customer behavior pattern information. Further, the components xₙ₊₁-x_{N} indicate feature amounts in the area information. In the customer behavior pattern information, the values of xₙ₊₁-x_{N} may be 0. Likewise, in the area information, the values of x₁-xₙ may also be 0.

In the example shown in FIG. 5, regarding the feature amounts included in the customer behavior pattern information, the component x₁ indicates the position of the vehicle 2 (vehicle position) of the corresponding customer at the corresponding time (sampling time). Further, the component x₂ indicates the residual amount of hydrogen of the vehicle 2 of the corresponding customer at the corresponding time (sampling time). The residual amount of hydrogen may be a fuel percentage (State Of Charge: SOC).

Further, the component x₃ indicates a hydrogen station that the corresponding customer has visited in order to fuel the vehicle 2 with hydrogen at the corresponding time (sampling time). Note that the component value of x₃ is predetermined for each hydrogen station, like “hydrogen station A: x₃=1” and “hydrogen station B: x₃=2”. When the customer has not visited a hydrogen station at the corresponding time (sampling time), the component value of x₃ may be 0.

Further, the component x₄ indicates the fueling amount of hydrogen with which the vehicle 2 of the corresponding customer has been fueled. The fueling amount may be a fuel percentage increased when the vehicle 2 has been fueled with hydrogen. When the customer has not fueled the vehicle 2 with hydrogen at the corresponding time (sampling time), the component value of x₄ may be 0. Further, the component x₅ indicates reservation information regarding the corresponding customer. The reservation information indicates whether the customer has made a reservation in advance to visit a hydrogen station and fuel his/her vehicle with hydrogen at the corresponding time (sampling time). The component value of x₅ may be predetermined depending on whether there is a reservation, like “reserved: x₅=1” and “no reservation: x₅=0”.

Further, the component x₆ indicates a visit frequency at which the corresponding customer visits each hydrogen station. Further, the component x₇ indicates a fueling frequency at which the corresponding customer fuels his/her vehicle 2 with hydrogen. Further, the component x₈ indicates a seasonal variation in the behavior pattern of the corresponding customer. As will be described later, x₆-x₈ may not be time-series data and may be derived from the customer behavior pattern information. Therefore, x₆-x₈ may not be included as the feature amounts.

Regarding the feature amounts included in the area information, in the example shown in FIG. 5, the component xₙ₊₁ indicates the weather in the corresponding area at the corresponding time (sampling time). The component value of xₙ₊₁ is predetermined for each type of weather (e.g., fine or rainy), like “fine: xₙ₊₁=1” and “rainy: xₙ₊₁=2”. Further, the component xₙ₊₂ indicates the temperature in the corresponding area at the corresponding time (sampling time). Further, the component xₙ₊₃ indicates the operation status of the hydrogen station provided in the corresponding area at the corresponding time (sampling time). The operation status indicates, for example, whether or not the corresponding hydrogen station is operating for each day of a week and for each time of a day (i.e., for each period of time). Further, the component xₙ₊₄ indicates event holding information in the corresponding area. The event holding information may indicate the type of an event held at the corresponding time (sampling time) and the size of the event (e.g., the number of persons that can be accommodated at an event venue).

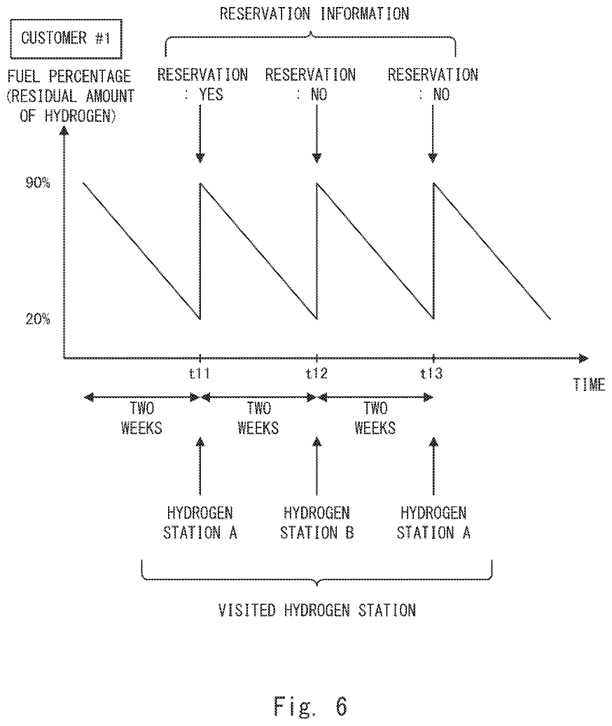

FIGS. 6-9 are diagrams illustrating customer behavior patterns according to the first embodiment. The customer behavior patterns illustrated in FIGS. 6-9 are shown by graphs, in which the horizontal axis indicates time and the vertical axis indicates the fuel percentage of hydrogen (residual amount of hydrogen) of the vehicle 2 of the corresponding customer. Therefore, the customer behavior patterns are time-series data. Note that FIGS. 6-9 each indicate the time course of the fuel percentage of hydrogen. Therefore, the time course of the fuel percentage in each of FIGS. 6-9 corresponds to the “residual amount of hydrogen”, which is one of the feature amounts illustrated in FIG. 5. Note that the customer behavior pattern may indicate the time course of the position of the corresponding vehicle 2. In this case, the time course of the position of the vehicle 2 corresponds to the “vehicle position”, which is one of the feature amounts illustrated in FIG. 5.

FIG. 6 illustrates a customer behavior pattern of the customer #1. In the customer behavior pattern illustrated in FIG. 6, the fuel percentage of the vehicle 2 of the customer #1 drops to 20% after about two weeks from the time when the fuel percentage of hydrogen is 90%. When the fuel percentage has dropped to 20% the first time (time t11), the customer #1 visits the hydrogen station A and fuels the vehicle 2 with hydrogen so that the fuel percentage is raised from 20% to 90% %, that is, this customer fuels his/her vehicle 2 with hydrogen so that the amount of hydrogen fueled corresponds to the fuel percentage of 70%. In this visit, the customer #1 has made a reservation to visit the hydrogen station A and fuel his/her vehicle with hydrogen.

Further, when the fuel percentage has dropped to 20% the second time (time t₁₂), the customer #1 visits the hydrogen station B and fuels the vehicle 2 with hydrogen so that the fuel percentage is raised from 20% to 90%, i.e., that is, this customer fuels his/her vehicle 2 with hydrogen with the fuel percentage of 70%. At this time, the customer #1 has not made a reservation to visit the hydrogen station B and fuel his/her vehicle with hydrogen. Further, when the fuel percentage drops to 20% the third time (time t13), the customer #1 visits the hydrogen station A and fuels his/her vehicle with hydrogen so that the fuel percentage is raised from 20% to 90%, that is, this customer fuels his/her vehicle 2 with hydrogen with the fuel percentage of 70%. In this visit, the customer #1 has not made a reservation to visit the hydrogen station A and fuel his/her vehicle with hydrogen.

In the customer behavior pattern illustrated in FIG. 6, the customer having visited the hydrogen station A, the hydrogen station B, and the hydrogen station A at time t11, time t12, and time t13, respectively corresponds to “visited hydrogen station”, which is one of the feature amounts illustrated in FIG. 5. Further, the vehicle having been fueled with hydrogen whose amount corresponds to the fuel percentage of 70% at time t₁₁, time t₁₂, and time t₁₃ corresponds to “fueling amount per time”, which is one of the feature amounts illustrated in FIG. 5. Further, that “reservation: yes”, “reservation: no”, and “reservation: no” at time t₁₁, time t₁₂, and time t₁₃, respectively, corresponds to “reservation information”, which is one of the feature amounts illustrated in FIG. 5.

Further, the customer #1 having visited the hydrogen station A at time t₁₁ and time t₁₃ and visited the hydrogen station B at time t₁₂ correspond to “visit frequency for each hydrogen station”, which is one of the feature amounts illustrated in FIG. 5. Further, the vehicle having been fueled with hydrogen every two weeks corresponds to “fueling frequency”, which is one of the feature amounts illustrated in FIG. 5.

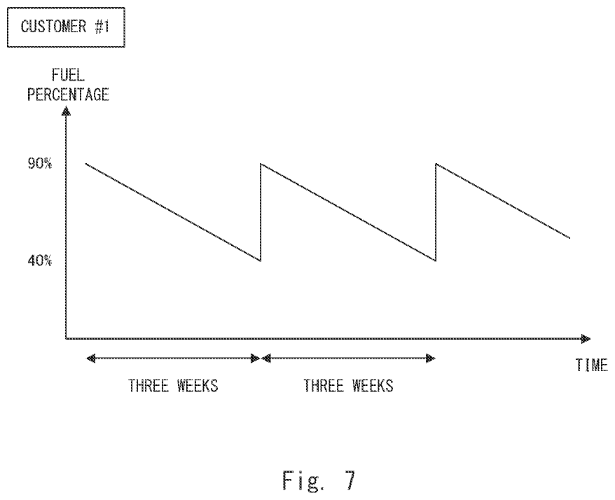

FIG. 7 illustrates a customer behavior pattern of the customer #1 in a season that is different from that shown in FIG. 6. FIG. 6 corresponds to the customer behavior pattern during summer and FIG. 7 corresponds to the customer behavior pattern during winter. In summer, the customer #1 fuels the vehicle 2 with hydrogen when the fuel percentage drops to 20%, whereas in winter, the customer #1 fuels the vehicle 2 with hydrogen when the fuel percentage drops to 40% %. That is, in winter, the customer #1 fuels the vehicle 2 with hydrogen before the fuel percentage drops to the fuel percentage based on which the customer #1 fuels the vehicle 2 with hydrogen in summer. On the other hand, in summer, the customer #1 fuels the vehicle 2 with hydrogen every two weeks, whereas in winter, the customer #1 fuels the vehicle 2 with hydrogen every three weeks. That is, the customer #1 fuels the vehicle 2 with hydrogen less frequently in winter than in summer. In this manner, the behavior patterns varying depending on the season corresponds to “seasonal variation”, which is one of the feature amounts illustrated in FIG. 5.

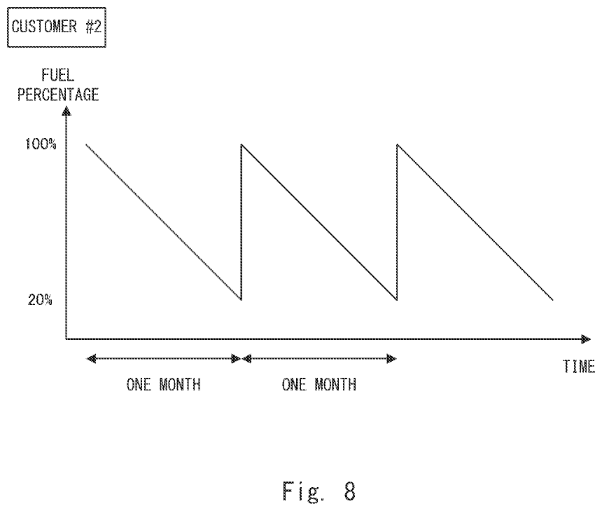

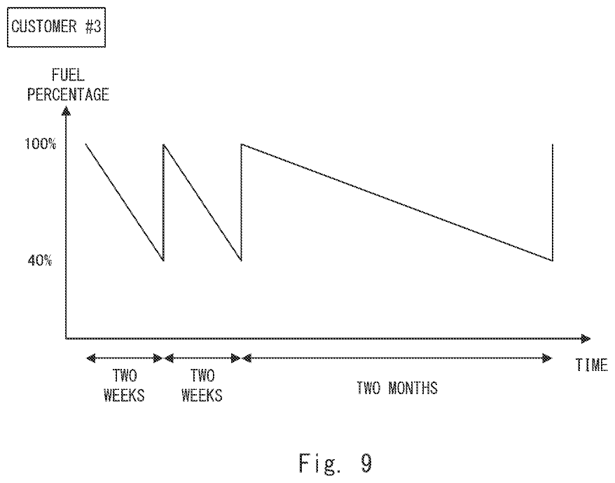

FIG. 8 illustrates a customer behavior pattern of the customer #2. Further, FIG. 9 illustrates a customer behavior pattern of the customer #3. It is assumed that the time axis in FIG. 8 is the same as that in FIG. 9. As illustrated in FIG. 8, the customer #2 fuels the vehicle 2 with hydrogen every month. Further, the customer #2 fuels the vehicle 2 with hydrogen when the fuel percentage drops to 20%. On the other hand, as illustrated in FIG. 9, the customer #3 normally fuels the vehicle 2 with hydrogen every two weeks, but sometimes does not fuel the vehicle 2 with hydrogen for two months. Further, the customer #3 fuels the vehicle 2 with hydrogen when the fuel percentage drops to 40%. That is, the customer #3 fuels the vehicle 2 with hydrogen more frequently than the customer #2 does. Further, the customer #3 fuels the vehicle 2 with hydrogen before the fuel percentage drops to the fuel percentage based on which the customer #2 fuels the vehicle 2 with hydrogen. Further, the customer #2 fuels the vehicle 2 with hydrogen at a substantially constant cycle, whereas the cycle at which the customer #3 fuels the vehicle 2 with hydrogen is not constant since there is a period in which the customer #3 consumes only a small amount of hydrogen. In this manner, different customers may have different behavior patterns.

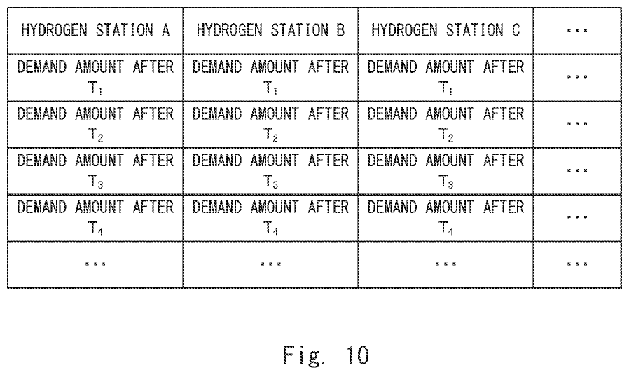

FIG. 10 is a diagram illustrating output data output from the demand prediction model according to the first embodiment. As illustrated in FIG. 10, a predicted demand amount of hydrogen after a predetermined period at each hydrogen station is output from the demand prediction model. In the example shown in FIG. 10, regarding the hydrogen station A, a demand amount of hydrogen after the period T₁, a demand amount of hydrogen after the period T₂, a demand amount of hydrogen after the period T₃, and a demand amount of hydrogen after the period T₄ are output from the demand prediction model. The same is applicable to the hydrogen stations B and C.

Incidentally, in the training data used at the learning stage, the ground truth data may correspond to the output data illustrated in FIG. 10. Therefore, regarding the hydrogen station A, the ground truth data may be the actual demand amount of hydrogen after the period T₁, the period T₂, the period T₃, and the period T₄ from the last time point on the time series (this corresponds to tₖ in FIG. 4) of the input customer behavior pattern information.

At the learning stage, regarding the customer behavior pattern information, information prior to the prediction target timing of the hydrogen demand (a time point after a predetermined period, like after the period T₁) may be used as the input data. At the operational stage, regarding the customer behavior pattern information, past information on the time series may be used as the input data. This is because it is substantially difficult to acquire future customer behavior pattern information at the operational stage. Note that, in the customer behavior pattern information, regarding reservation information, when there is a reservation at a prediction target timing, information up to the prediction target timing (future information) may be used as the input data.

On the other hand, regarding the area information, information up to the prediction target timing may also be used as the input data. That is, at the operational stage, regarding the area information, future information may also be used as the input data. In the example shown in FIG. 5, “weather” and “temperature” can be acquired from a weather forecast. Further, “operation status of hydrogen station” can be acquired from an operation schedule of the hydrogen station. Further, the “event holding information” can be acquired from a schedule of an event.

When the demand prediction model learning unit 104 learns demand prediction after the period T₁ at time T₀, it may learn the demand prediction model by receiving input data for a period ΔT tracked back from T₀ and using the actual demand amount of hydrogen after the period T₁ from time T₀ as the ground truth data. The symbol ΔT corresponds to a period from t₁ to tₖ in the time axis shown in FIG. 4. Note that ΔT>Δt is established. When, for example, the sampling period Δt is 30 minutes, the input data for the past six hours from T₀ may be input to the demand prediction model, assuming that ΔT=six hours. Further, when the sampling period Δt is 24 hours, the input data for the past one month from T₀ may be input to the demand prediction model, assuming that ΔT=one month. Alternatively, when the sampling period Δt is 24 hours, the input data for the past one year from T₀ may be input to the demand prediction model, assuming that ΔT=one year.

After the learning of the demand prediction model is ended, the demand prediction model learning unit 104 outputs the trained demand prediction model to the trained model storage unit 122. Accordingly, the trained model storage unit 122 stores the demand prediction model, which is a trained model generated by machine learning in advance. Then, the demand prediction model, which is the trained model, receives the input data, which is time-series data including the feature amounts such as those illustrated in FIGS. 4 and 5, and outputs the predicted demand of hydrogen for each hydrogen station as illustrated in FIG. 10.

Further, the learning unit 100 may continuously perform learning on the demand prediction model in accordance with a difference between the demand predicted by the prediction unit 140 that will be described later and the actual demand. The details thereof will be described later.

The input data acquisition unit 124 acquires the aforementioned input data at the operational stage. The input data acquisition unit 124 at least acquires the customer behavior pattern (customer behavior pattern information) as the input data. The input data acquisition unit 124 acquires the customer behavior pattern information, which is the input data, from each of the vehicles 2 using the interface unit 18 via the network 1a. Further, the input data acquisition unit 124 acquires area information as the input data. Further, the input data acquisition unit 124 acquires, for example, the customer behavior pattern information, which is time-series data between the current time point and a time point tracked back for a predetermined period from the current time point. Further, the input data acquisition unit 124 acquires, for example, the area information, which is time-series data between a time point tracked back for a predetermined period from the present and a future time point regarding which information can be acquired.

The prediction unit 140 predicts the demand for hydrogen at least one hydrogen station using the demand prediction model stored in the trained model storage unit 122. That is, the prediction unit 140 predicts the demand for hydrogen at at least one hydrogen station using the demand prediction model that receives at least the customer behavior pattern information and outputs the predicted demand for hydrogen.

The demand prediction unit 142 inputs the input data acquired by the input data acquisition unit 124 to the demand prediction model stored in the trained model storage unit 122. Accordingly, the demand prediction model outputs the prediction demand amount of hydrogen for each hydrogen station as illustrated in FIG. 10. Accordingly, the demand prediction unit 142 predicts the demand amount of hydrogen for each hydrogen station.

As described above, the demand prediction unit 142 (the prediction unit 140) is configured to predict the demand for hydrogen at at least one hydrogen station using the demand prediction model that receives at least the customer behavior pattern information and outputs the predicted demand for hydrogen. Accordingly, the information processing apparatus 10 according to the first embodiment is able to accurately predict the demand for hydrogen at hydrogen stations. That is, since the information processing apparatus 10 is configured to predict the demand for hydrogen using behavior patterns of customers, it is possible to predict the demand for hydrogen even when a customer does not make a reservation to visit a hydrogen station and fuel his/her vehicle with hydrogen. Accordingly, the information processing apparatus 10 according to the first embodiment is able to accurately predict the demand for hydrogen.

Further, it can be said, from the feature amounts “residual amount of hydrogen”, “visited hydrogen station”, and “fueling amount per time”, illustrated in FIG. 5, that the customer behavior pattern information, which is the time-series data, indicates a timing when a customer fuels his/her vehicle with hydrogen. That is, the timing when the component value of the feature amount “residual amount of hydrogen” has been increased and the component values of the feature amounts “visited hydrogen station” and “fueling amount per time” have been changed corresponds to the timing when the customer has fueled the vehicle with hydrogen. Therefore, the demand prediction unit 142 predicts the demand for hydrogen using the timing when the customer fuels his/her vehicle with hydrogen, which is indicated by the customer behavior pattern information. Since the demand prediction unit 142 (the prediction unit 140) predicts the demand for hydrogen as described above, the accuracy of predicting the demand for hydrogen may be improved. That is, the timing when the customer fuels his/her vehicle with hydrogen is often at a substantially constant cycle. Therefore, the demand prediction model is adjusted so that it is predicted that the demand increases at the timing corresponding to this cycle, whereby the prediction accuracy may be improved.

Further, as illustrated in FIG. 5, the customer behavior pattern information includes the vehicle position. Therefore, the demand prediction unit 142 predicts the demand for hydrogen using the vehicle position of the customer, which is indicated by the customer behavior pattern information. Further, as illustrated in FIG. 5, the customer behavior pattern information includes the residual amount of hydrogen. Therefore, the demand prediction unit 142 predicts the demand for hydrogen using the residual amount of hydrogen of the vehicle 2 of the customer, which is indicated by the customer behavior pattern information. The demand prediction unit 142 (the prediction unit 140) predicts the demand for hydrogen as described above, whereby the accuracy of predicting the demand for hydrogen may be improved. That is, the customer is highly likely to visit a hydrogen station at a timing when, for example, the residual amount of hydrogen of the vehicle 2 of the customer has fallen to the extent that it needs to be fueled with hydrogen (the fuel percentage is 20% in the examples shown in FIGS. 6 and 8 and the fuel percentage is 40% in the examples shown in FIGS. 7 and 9). Further, the customer is likely to visit a hydrogen station located close to the vehicle position at the above timing. Therefore, the demand prediction model is adjusted so that it is predicted, at the above timing, that the demand at a hydrogen station near the vehicle position at this timing will increase, whereby the prediction accuracy may be improved.

Further, as illustrated in FIG. 5, the customer behavior pattern information includes reservation information. Therefore, the demand prediction unit 142 predicts the demand for hydrogen using reservation information from the customer, which is indicated by the customer behavior pattern information. Since the demand prediction unit 142 (the prediction unit 140) predicts the demand for hydrogen as described above, the accuracy of predicting the demand for hydrogen may be improved. That is, the customer is highly likely to visit the hydrogen station at a timing that corresponds to the reservation information. Therefore, the demand prediction model is adjusted so that it is predicted that the demand increases at the above timing, whereby the prediction accuracy may be improved.

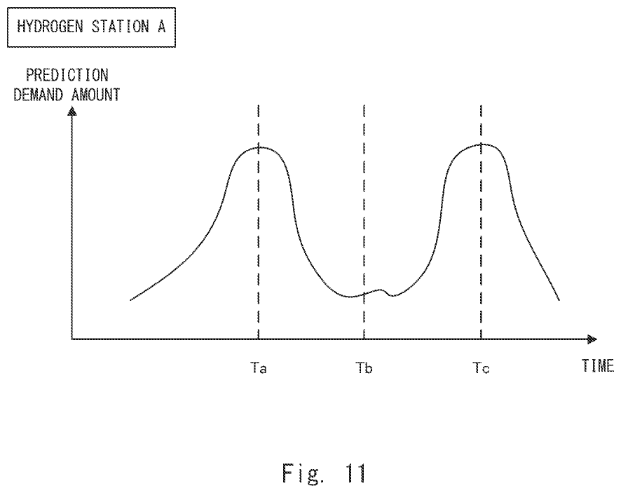

FIG. 11 is a diagram illustrating demand prediction obtained by the demand prediction unit 142 according to the first embodiment. FIG. 11 illustrates the demand prediction at the hydrogen station A. Further, FIG. 11 shows a graph where the horizontal axis is the time axis and the vertical axis indicates the prediction demand amount. As illustrated in FIG. 10, the prediction demand amounts at a plurality of timings (after T₁, after T₂, after T₃, after T₄, . . . ) are output from the demand prediction model. Accordingly, the graph illustrated in FIG. 11 may be generated by plotting the prediction demand amounts at these plurality of timings.

According to the demand prediction illustrated in FIG. 11, the demand is high at a timing that corresponds to Ta. Further, the demand is low at a timing that corresponds to Tb. Further, the demand is high at a timing that corresponds to Tc. Note that Ta, Tb, and Tc may each indicate a time, a time of a day (i.e., a period of time), or a date. Whether each timing indicates the time, the time of a day, or the date may depend on demand prediction of which timing will be performed. When, for example, the demand prediction model is configured to perform demand prediction for each time of a day in one day, the above timings may each indicate the time of a day. Further, when the demand prediction model is configured to perform demand prediction for each date in one week or one month, the above timings may each indicate the date.

The suppliable amount decision unit 144 decides the amount of hydrogen that can be supplied (suppliable amount) in accordance with a timing based on the predicted demand. Specifically, the suppliable amount decision unit 144 decides the suppliable amount so as to increase the suppliable amount at a timing when it is predicted that there is a high demand for hydrogen. On the other hand, the suppliable amount decision unit 144 decides the suppliable amount so as to decrease the suppliable amount at a timing when it is predicted that there is a low demand for hydrogen. In the example shown in FIG. 11, the suppliable amount decision unit 144 decides, regarding the hydrogen station A, the suppliable amount at each timing in such a way that the suppliable amount at the timing Ta becomes larger than the suppliable amount at the timing Tb. Likewise, the suppliable amount decision unit 144 decides, regarding the hydrogen station A, the suppliable amount at each timing in such a way that the suppliable amount at the timing Tc becomes larger than the suppliable amount at the timing Tb.

As described above, the suppliable amount decision unit 144 (the prediction unit 140) decides an amount of hydrogen that can be supplied (suppliable amount) in accordance with a timing based on a predicted demand, whereby it becomes possible to stabilize revenues at hydrogen stations. That is, by increasing the suppliable amount at a timing when it is predicted that there is a high demand for hydrogen, it is possible to prevent opportunity loss that a hydrogen station cannot supply hydrogen when a customer visits the hydrogen station in order to fuel the vehicle 2 with hydrogen. Further, by decreasing the suppliable amount at a timing when it is predicted that there is a low demand for hydrogen, it is possible to prevent the loss due to excessive preparation. Therefore, it becomes possible to stabilize revenues at hydrogen stations.

Further, the suppliable amount decision unit 144 may decide the hydrogen preparation amount in accordance with the timing when hydrogen is ordered based on the predicted demand for hydrogen. Specifically, the suppliable amount decision unit 144 decides, for each of the hydrogen stations, the hydrogen preparation amount that corresponds to the demand in a period according to the frequency of orders. When, for example, the hydrogen station A orders hydrogen every week, the suppliable amount decision unit 144 decides, for the hydrogen station A, a hydrogen preparation amount that corresponds to the predicted demand for hydrogen for one week. The hydrogen preparation amount may be decided, for example, by adding up the prediction demand amounts at the respective timings when the demand is predicted in one week. In this way, the suppliable amount decision unit 144 (the prediction unit 140) decides the hydrogen preparation amount in accordance with the timing when hydrogen is ordered based on the predicted demand for hydrogen, whereby it is possible to further reduce the opportunity loss or excessive preparation described above.

Further, the suppliable amount decision unit 144 may decide the timing when high-pressure gas of hydrogen is prepared based on the predicted demand. Specifically, when the demand for hydrogen is predicted for each time of a day in one day, the suppliable amount decision unit 144 decides the timing when high-pressure gas (high-pressure hydrogen) is prepared in such a way that the high-pressure gas is prepared a predetermined period of time before (e.g., one hour ago) the time of a day when the demand becomes high. Note that the “predetermined period of time” may be set as appropriate in accordance with time required to increase the pressure of hydrogen. At hydrogen stations, even if hydrogen is prepared, it cannot be supplied to the vehicles 2 unless the pressure of hydrogen is increased in advance. Therefore, by deciding the timing when high-pressure gas of hydrogen is prepared based on the predicted demand, it becomes possible to prevent the opportunity loss that hydrogen cannot be supplied to the vehicles 2 when customers visit a hydrogen station.

The notification unit 150 notifies a customer of a timing and a hydrogen station where hydrogen can be supplied in accordance with the predicted demand. The notification unit 150 sends a notification (a suppliable notification) indicating a hydrogen station that can supply hydrogen and the timing (time of a day) when this hydrogen station can supply hydrogen to a customer's device via the network 1a using the interface unit 18.

Specifically, the notification unit 150 determines, for each of the hydrogen stations, a timing when it is predicted that there is a demand for hydrogen. For example, the notification unit 150 determines, for each of the hydrogen stations, the timing when it is predicted that the demand amount of hydrogen is equal to or larger than a predetermined value. Then, the notification unit 150 sets, for each of the hydrogen stations, the timing when it is predicted that there is a demand for hydrogen as the timing when hydrogen can be supplied. Then, the notification unit 150 generates a suppliable notification in accordance with the hydrogen station and the timing. The notification unit 150 transmits the generated suppliable notification.

The notification unit 150 may transmit the suppliable notification to, for example, the vehicle 2 of the customer. Accordingly, the suppliable notification is displayed in the vehicle 2. In this case, the notification unit 150 may display the suppliable notification using a navigation system mounted on the vehicle 2. For example, when the hydrogen station that can supply hydrogen is displayed on the screen of the navigation system, the notification unit 150 may cause the screen to display the timing when hydrogen can be supplied at this hydrogen station.

Further, the notification unit 150 may transmit the suppliable notification to, for example, a terminal (e.g., a smartphone) owned by a customer. In this case, the notification unit 150 may perform, on a navigation system that can be implemented by the customer's terminal, processing similar to the processing performed on the navigation system of the vehicle 2 stated above. Alternatively, the notification unit 150 may cause the terminal to display a list in which the hydrogen station is associated with the timing when hydrogen can be supplied.

Alternatively, the notification unit 150 may cause the suppliable notification to be shown on the website of hydrogen station. In this case, the notification unit 150 may cause a map to be shown on the website, and show a timing when hydrogen can be supplied at the hydrogen station displayed on the map. Alternatively, the notification unit 150 may display a list in which hydrogen stations are associated with timings when hydrogen can be supplied on the website.

The notification unit 150 notifies the customer of a timing and a hydrogen station where hydrogen can be supplied in accordance with the predicted demand, whereby customers may be supplied with hydrogen in a more convenient manner. It is advantageous for hydrogen stations as well since they are more likely to be able to reliably supply the hydrogen they have prepared. Therefore, by sending the above notification to the customers, it becomes possible to adjust demand for hydrogen and supply of hydrogen more reliably.

Further, when the notification unit 150 notifies the customer of the hydrogen station that can supply hydrogen and the timing when hydrogen can be supplied, it may notify the customer of the price of hydrogen as well. Accordingly, the customer is able to concurrently know the price of hydrogen and the timing when he/she is able to fuel the vehicle 2 with hydrogen, whereby convenience for customers is improved.

The learning continuation processing unit 160 performs processing for continuing learning of the demand prediction model. Specifically, the learning continuation processing unit 160 acquires the actual value (the actual demand amount) that corresponds to the predicted value of demand. Then, the learning continuation processing unit 160 performs continuation processing of learning (learning continuation processing) by the learning unit 100 in accordance with the difference between the predicted value of demand and the actual value of demand. Further specifically, the learning continuation processing unit 160 performs the learning continuation processing when the difference between the predicted value of demand and the actual value of demand is equal to or larger than a predetermined threshold. That is, the case in which the difference between the predicted value of demand and the actual value of demand has become large is a case in which it is possible that the accuracy of demand prediction by the demand prediction model has been decreased. Therefore, in this case, it is preferable that the demand prediction model be relearned. The above threshold may be defined as appropriate in accordance with the required accuracy of the demand.

The learning continuation processing may be performed, for example, in the following manner. The learning continuation processing unit 160 acquires customer behavior pattern information (and area information) up to the time point when the difference between the predicted value of demand and the actual value of demand has become equal to or larger than a predetermined threshold as the input data. Further, the learning continuation processing unit 160 acquires the actual value of demand obtained by this time point as the ground truth data. At this time point, time has passed since the stage of learning the demand prediction model. Therefore, the amount of input data acquired at this time point may become larger than the amount of input data used at the stage of learning the demand prediction model. Then, the learning continuation processing unit 160 performs processing so as to relearn the demand prediction model using a set of the acquired input data and the ground truth data as training data. Accordingly, the learning unit 100 performs relearning of the demand prediction model.

Note that the learning continuation processing may not be immediately executed at the time point when the difference between the predicted value of demand and the actual value of demand has become equal to or larger than the threshold. For example, the learning continuation processing may be executed when the difference between the predicted value of demand and the actual value of demand becomes equal to or larger than the threshold a predetermined number of times or more.

As described above, the information processing apparatus 10 may continuously perform learning of the algorithm of machine learning in accordance with the difference between the demand predicted by the prediction unit 140 and the actual demand. According to this configuration, the demand prediction model is adjusted in accordance with the actual operation, whereby it is possible to further improve the accuracy of predicting the demand.

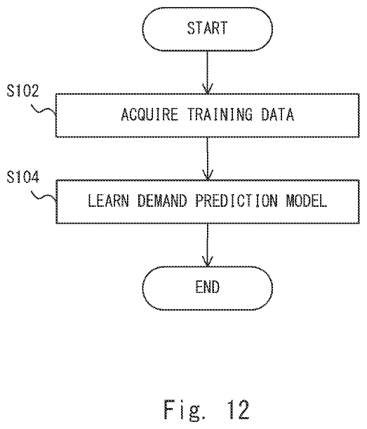

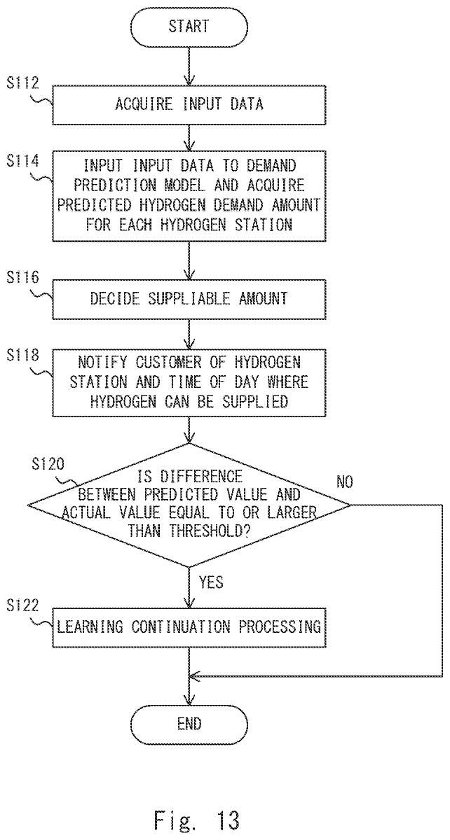

FIGS. 12 and 13 are flowcharts showing the information processing method executed by the information processing apparatus 10 according to the first embodiment. The flowcharts shown in FIGS. 12 and 13 correspond to the demand prediction method for predicting the demand for hydrogen.

FIG. 12 shows processing at the stage of learning the demand prediction model. As described above, the training data acquisition unit 102 acquires training data, which is a set of input data and ground truth data (Step S102). As described above, the demand prediction model learning unit 104 performs processing of learning the demand prediction model using the acquired training data (Step S104).

FIG. 13 shows processing at the operational stage of the demand prediction model. As described above, the input data acquisition unit 124 acquires input data (Step S112). As described above, the input data at least includes customer behavior patterns (customer behavior pattern information).

As described above, the demand prediction unit 142 inputs input data to the demand prediction model, which is the trained model, and acquires the predicted hydrogen demand amount for each hydrogen station (Step S114). As described above, the suppliable amount decision unit 144 decides the suppliable amount based on the predicted demand (Step S116). As described above, the notification unit 150 notifies the customer of the hydrogen station and the time of a day (timing) where hydrogen can be supplied (Step S118).

The learning continuation processing unit 160 determines whether the difference between the predicted value of demand and the actual value of demand is equal to or larger than the predetermined threshold (Step S120). When the difference between the predicted value of demand and the actual value of demand is equal to or larger than the threshold (YES in S120), the learning continuation processing unit 160 performs learning continuation processing, as described above (Step S122). On the other hand, when it is not determined that the difference between the predicted value of demand and the actual value of demand is equal to or larger than the threshold (NO in S120), the processing of S122 is not performed. Then the processing in S112-S122 may be repeated.

### Second Embodiment

Next, a second embodiment will be described. The second embodiment is different from the first embodiment in that a hydrogen station group composed of a plurality of hydrogen stations is taken into account in the second embodiment. Since the configuration of an information processing system 1 according to the second embodiment is substantially similar to that of the information processing system 1 according to the first embodiment shown in FIG. 1, the descriptions thereof will be omitted. Further, since the hardware configuration of an information processing apparatus 10 according to the second embodiment is substantially similar to that of the information processing apparatus 10 according to the first embodiment shown in FIG. 2, the descriptions thereof will be omitted.

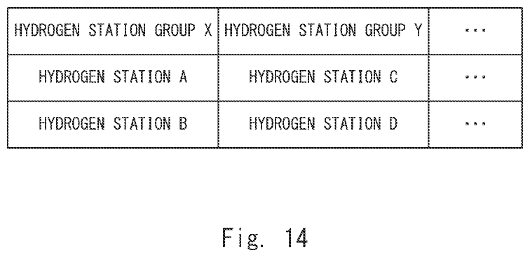

FIG. 14 is a diagram illustrating the hydrogen station group according to the second embodiment. As illustrated in FIG. 14, a hydrogen station group is composed of a plurality of hydrogen stations. For example, a hydrogen station group X is composed of a hydrogen station A and a hydrogen station B. In other words, the hydrogen station A and the hydrogen station B belong to the hydrogen station group X. Further, a hydrogen station group Y is composed of a hydrogen station C and a hydrogen station D. In other words, the hydrogen station C and the hydrogen station D belong to the hydrogen station group Y. Note that one hydrogen station may belong to a plurality of hydrogen station groups.

The hydrogen station group may be composed of, for example, a plurality of hydrogen stations that purchase hydrogen from the same supplier (e.g., hydrogen manufacturer). Further, the hydrogen station group may be composed of, for example, a plurality of hydrogen stations provided in the same area. Note that the number of hydrogen stations that compose a hydrogen station group may be any number equal to or larger than two. Further, different hydrogen station groups may be composed of different numbers of hydrogen stations.

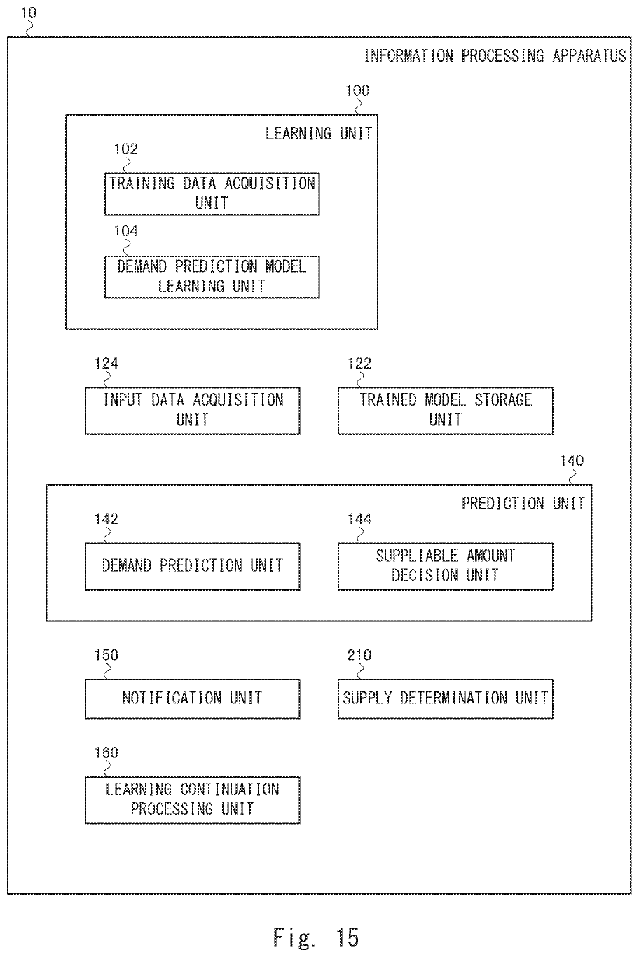

FIG. 15 is a block diagram showing a configuration of the information processing apparatus 10 according to the second embodiment. The information processing apparatus 10 according to the second embodiment includes components that are substantially the same as those of the information processing apparatus 10 according to the first embodiment shown in FIG. 3. The information processing apparatus 10 according to the second embodiment further includes a supply determination unit 210. Since the functions of the components of the information processing apparatus 10 according to the second embodiment similar to the components of the information processing apparatus 10 according to the first embodiment shown in FIG. 3 are substantially similar to the functions of the components of the information processing apparatus 10 according to the first embodiment unless otherwise stated, the descriptions thereof will be omitted.

The supply determination unit 210 determines whether or not each hydrogen station is able to actually supply hydrogen that corresponds to a predicted demand. Specifically, the supply determination unit 210 acquires an actual suppliable amount at a timing when demand is predicted at each hydrogen station. The actual suppliable amount may be different from the suppliable amount decided by the suppliable amount decision unit 144. That is, in some cases, hydrogen cannot be prepared in accordance with the predicted demand. In this case, the actual suppliable amount may become smaller than the suppliable amount decided by the suppliable amount decision unit 144 (i.e., the predicted demand amount).

The supply determination unit 210 compares, for each hydrogen station, the predicted demand amount with the actual suppliable amount at the timing when the demand is predicted. Then, the supply determination unit 210 determines, when the actual suppliable amount is smaller than the predicted demand amount, that it is possible that a sufficient amount of hydrogen may not be supplied to customers at this timing at this hydrogen station.

In the above case, the supply determination unit 210 decides to notify (suggest) the customer of another hydrogen station capable of supplying hydrogen in a hydrogen station group to which the above hydrogen station that cannot supply a sufficient amount of hydrogen belongs. Further, the supply determination unit 210 determines, regarding the other hydrogen station, that the actual suppliable amount is equal to or larger than the predicted demand amount at this timing.

Accordingly, in the above case, the notification unit 150 notifies the customer that hydrogen can be supplied at another hydrogen station capable of supplying hydrogen in the hydrogen station group to which the above hydrogen station that cannot supply a sufficient amount of hydrogen belongs. Assume, for example, a case in which the actual suppliable amount at the hydrogen station A at one timing is smaller than the predicted demand amount, whereas the actual suppliable amount at the hydrogen station B at the same timing is equal to or larger than the predicted demand amount. In this case, the notification unit 150 notifies the customer that hydrogen can be supplied at the hydrogen station B included in the hydrogen station group X to which the hydrogen station A belongs. That is, the notification unit 150 may not notify that the hydrogen station A is able to supply hydrogen at the above timing.

The information processing apparatus 10 according to the second embodiment is configured to notify, when one hydrogen station cannot supply a sufficient amount of hydrogen in accordance with the predicted demand at one timing, the customer of another hydrogen station that can supply a sufficient amount of hydrogen at the same timing. Accordingly, it is possible to prevent an imbalance in the hydrogen supply, that is, a situation in which it is likely that one hydrogen station in a hydrogen station group will not be able to supply hydrogen, while it is likely that another hydrogen station which belongs to the same hydrogen station group will be able to supply hydrogen. That is, it becomes possible to balance the hydrogen supply in the hydrogen station group.

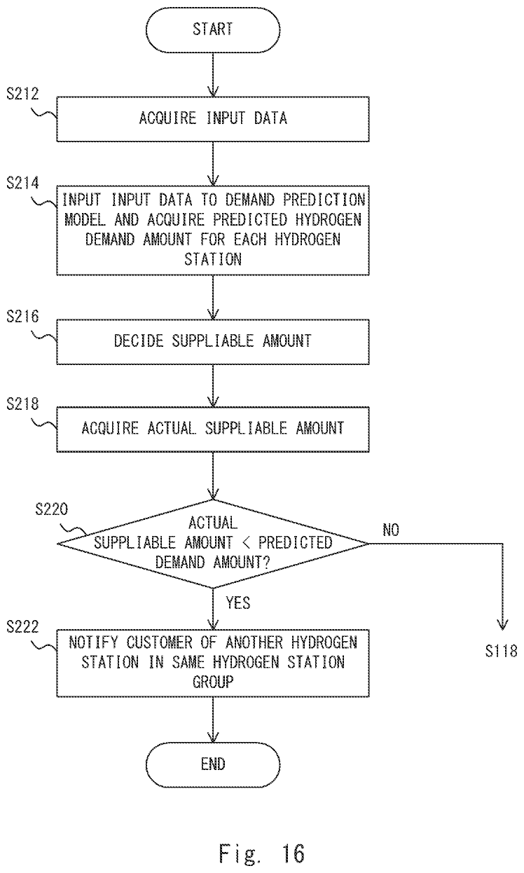

FIG. 16 is a flowchart showing an information processing method executed by the information processing apparatus 10 according to the second embodiment. FIG. 16 corresponds to a demand prediction method at the operational stage of the demand prediction model. Like in S112 shown in FIG. 13, the input data acquisition unit 124 acquires input data (including at least customer behavior pattern information) (Step S212). Like in S114 shown in FIG. 13, the demand prediction unit 142 inputs the input data to the demand prediction model, which is the trained model, and acquires the predicted hydrogen demand amount for each hydrogen station (Step S214). Like in S114 shown in FIG. 13, the suppliable amount decision unit 144 decides the suppliable amount based on the predicted demand (Step S216).

As described above, the supply determination unit 210 acquires, for one hydrogen station, the actual suppliable amount at the predicted timing (Step S218). The supply determination unit 210 determines whether or not the actual suppliable amount is smaller than the predicted demand amount (Step S220). When it is determined that the actual suppliable amount is smaller than the predicted demand amount (YES in S220), the notification unit 150 notifies the customer of another hydrogen station which is in a hydrogen station group to which the above hydrogen station that cannot supply a sufficient amount of hydrogen belongs, as described above (Step S222). On the other hand, when it is not determined that the actual suppliable amount becomes smaller than the predicted demand amount (NO in S220), the notification unit 150 does not perform processing of S222. In this case, the notification unit 150 may perform processing of S118.

### Modified Examples

Note that the present disclosure is not limited to the above embodiments and may be changed as appropriate without departing from the spirit of the present disclosure. For example, the order of the plurality of steps in the flowcharts described above may be changed as appropriate. Further, one or more steps of the flowcharts described above may be omitted as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An information processing apparatus comprising:
an acquisition unit configured to acquire a behavior pattern of a customer regarding a vehicle that uses hydrogen as a fuel; and
a prediction unit configured to predict demand for hydrogen at at least one hydrogen station using a demand prediction model, which is a trained model generated by machine learning in advance, the demand prediction model receiving at least the behavior pattern and outputting a predicted demand for hydrogen.

2. The information processing apparatus according to claim 1, wherein the prediction unit decides, based on the predicted demand, an amount of hydrogen that can be supplied in accordance with a timing.

3. The information processing apparatus according to claim 2, wherein the prediction unit decides, based on the predicted demand, a timing when high-pressure gas of hydrogen is prepared.

4. The information processing apparatus according to claim 1, wherein the prediction unit predicts the demand for hydrogen based on a timing when the customer fuels his/her vehicle with hydrogen, which is indicated by the behavior pattern.

5. The information processing apparatus according to claim 1, wherein the prediction unit predicts the demand for hydrogen based on reservation information from the customer, which is indicated by the behavior pattern.

6. The information processing apparatus according to claim 1, further comprising a learning unit configured to perform machine learning on the demand prediction model,
wherein the learning unit continuously performs learning on the demand prediction model in accordance with a difference between the demand predicted by the prediction unit and an actual demand.

7. The information processing apparatus according to claim 1, further comprising a notification unit configured to notify, in accordance with the predicted demand, a customer of a timing and a hydrogen station where hydrogen can be supplied.

8. The information processing apparatus according to claim 7, wherein
a hydrogen station group is composed of a plurality of hydrogen stations, and
the notification unit notifies the customer that, when an amount of hydrogen that can be actually supplied at one hydrogen station becomes lower than a predicted demand amount at this hydrogen station, hydrogen can be supplied at another hydrogen station capable of supplying hydrogen in the hydrogen station group to which the hydrogen station that cannot supply a sufficient amount of hydrogen belongs.

9. An information processing method comprising:
acquiring a behavior pattern of a customer regarding a vehicle that uses hydrogen as a fuel; and
predicting demand for hydrogen at least one hydrogen station using a demand prediction model, which is a trained model generated by machine learning in advance, the demand prediction model receiving at least the behavior pattern and outputting a predicted demand for hydrogen.

10. A Non-transitory computer readable medium storing a program for causing a computer to execute the following processing of:
acquiring a behavior pattern of a customer regarding a vehicle that uses hydrogen as a fuel; and
predicting demand for hydrogen at least one hydrogen station using a demand prediction model, which is a trained model generated by machine learning in advance, the demand prediction model receiving at least the behavior pattern and outputting a predicted demand for hydrogen.
